(19) United States
(12) Patent Application Publication
(10) Pub. No.: US 2007/0163160 A1
(43) Pub. Date: Jul. 19, 2007

(54) Gun Graffiti

(76) Inventor: Benjamin Lynn Frederick, Dewitt, MI (US)

Correspondence Address: Ben Frederick, 403 East Herbison, Dewitt, MI, 48820, US

(21) Appl. No.: 11/442,730

(22) Filed: May 30, 2006

Related U.S. Application Data
(60) Provisional application No. 60/759,747, filed on Jan. 19, 2006.

(51) Int. Cl. G09F 7/00

(52) U.S. Cl. 40/584

(57) ABSTRACT

A thin flat piece of material with material adhering mechanism 1 located on “Gun Graffiti” without placement 2 logo placing area 3.

### CROSS-REFERENCE TO RELATED APPLICATIONS

This application relates to and claims priority from U.S. Provisional Patent Application Ser. No. U.S. 60/759,747 filed on Jan. 19, 2006, specifications which are incorporated herein by reference.

### FEDERALLY SPONSORED RESEARCH

Not Applicable

### SEQUENCE LISTING OR PROGRAM

Not Applicable

### BACKGROUND OF THE INVENTION-FIELD OF INVENTION

This invention relates to a way of displaying sponsorship as well as team spirit in the paint ball industry, more over, it relates to a cover for the paint ball gun itself.

### BACKGROUND OF INVENTION

Paint ball is a fairly new sport which has come on strong in the last few years w/teams forming all over the globe. In fact, college teams are now forming and scholarships are being awarded at university all over the nation for paint ball enthusiast's. Yes it is an extreme sport as they call it, however; it is being recognized as a sport where one who has the talents of precision accuracy with a paint ball gun and speed can get paid through endorsements and make a living at it. This new innovative product will allow for individuals as well as teams to create funds through displaying products for other companies. To add, the new innovative product “Gun Graffiti” can be used to display team logos.

### BACKGROUND OF INVENTION-OBJECTS AND ADVANTAGES

Accordingly besides the objects and advantages of “Gun Graffiti” described in my above patent, several objects and advantages of the present invention are:

(a) “Gun Graffiti” will allow for more advertisement area within the paint ball industry

(b) “Gun Graffiti” will allow for athletes to stand out from the crowd and be unique.

(c) “Gun Graffiti” provides all levels of markers with the ability to effectively deliver whatever message the end user desires.

(d) “Gun Graffiti” will allow the end user to get his/her point across to the public.

(e) “Gun Graffiti” will offer the highest level of customization available, including but not limited to color schemes and logo enhancements.

(f) “Gun Graffiti” will allow an inexpensive way for advertisers to advertise.

(g) “Gun Graffiti will allow the end user to advertise with many different customers in a single day.

### SUMMARY

In accordance with the present invention, is comprised of a material with elastic said properties, included but not limited to an adhering mechanism.

In drawings, close related figures have same number but different numerical suffixes.

### DRAWINGS—FIGURES

FIG. 1 (1) illustrates a paint ball gun.

FIG. 1 (2) illustrates paint ball gun nozzle.

FIG. 1 (3) illustrates the logo placing area

FIG. 1 (4) illustrates “Gun Graffiti” in use.

FIG. 2 (1) illustrates material adhering mechanism seem.

FIG. 2 (2) illustrates “Gun Graffiti” without placement

FIG. 2 (3) illustrates logo placing area

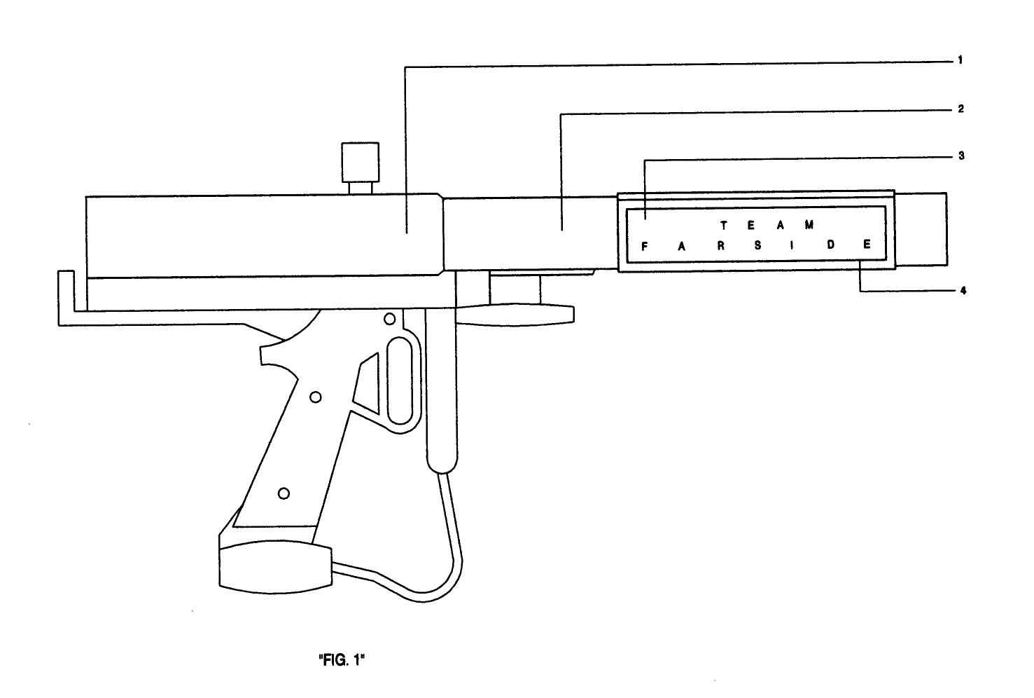

### DRAWINGS-REFERENCE NUMERALS FOR FIG. 1

| | |
|---|---|
| 1 Paint ball gun | 2 Paint ball gun nozzle |
| 3 Logo placing area | 4 “Gun Graffiti” in use. |

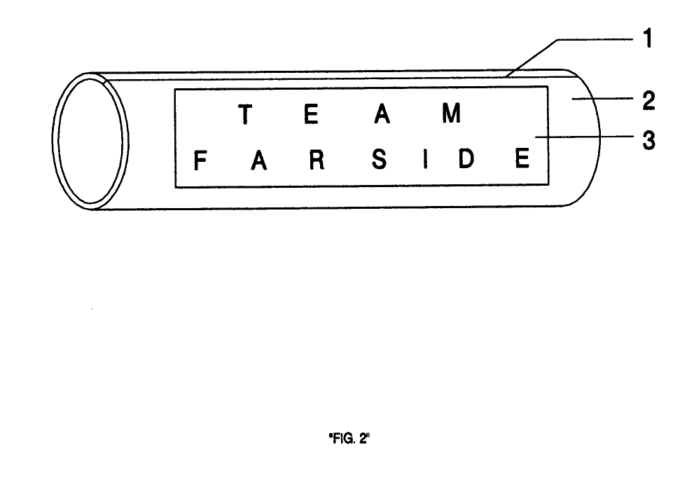

### DRAWINGS-REFERENCE NUMERALS FOR FIG. 2

| | |
|---|---|
| 1 Material adhering mechanism | 2 “Gun Graffiti” without placement |
| seem | |
| 3 Logo placing area | |

### DETAILED DESCRIPTION-FIGS. 1 (1)-1 (4) AND 2 (1)-2 (3)

A preferred embodiment of the “Gun Graffiti” placed on the nozzle of a paint ball gun is illustrated in FIG. 1 (side view) has the paint ball gun 1 with the paint ball gun nozzle 2 receiving the “Gun Graffiti” 3. FIG. 2 (ellipse view) comprising of the present invention removed from the FIG.

1 The logo placing area 3 is being illustrated visually close to the material adhering mechanism seem 1 which is all illustrated on “Gun Graffiti” without placement 2.

Operation-FIGS. 1 (1)-1(4)

In the manner of using “Gun Graffiti” when it is seemed at the manufacturing level it is similar to that in which an end user was to place an elongated tube with a diameter being greater than another elongated tube with lesser diameter and placing one end of the elongated tube with a greater diameter over the elongated tube with a lesser diameter and sliding the elongated tube with the greater diameter over the elongated tube with less greater diameter to an undetermined portion of the elongated tube or cannula.

Operation-FIGS. 2 (1)-2 (3)

FIG. 2 illustrates the “Gun Graffiti” placed on 2 paint ball gun nozzle where 3 logo placing area is located. FIG. 2 illustrates the “Gun Graffiti” 1 removed from paint ball gun nozzle 2 the material adhering mechanism 1 is located on above the logo placing area 3.

Advantages

From the description above a number of advantages of my “Gun Graffiti” become evident:

(a) Will allow for more advertisement area within the paint ball industry

(b) Will allow for athletes to stand out from the crowd and be unique.

(c) Provides all levels of markers with the ability to effectively deliver whatever message the end user desires.

(d) Will allow the end user to get his/her point across to the public.

(e) Will offer the highest level of customization available, including but not limited to color schemes and logo enhancements.

(f) Will allow an inexpensive way for advertisers to advertise.

(g) will allow the end user to advertise with many different customers in a single day.

Conclusion, Ramifications, And Scope

Accordingly the reader that the “Gun Graffiti” that this invention can be used an un determined amount of times.
The reader will conclude how the end user can maximize on profits from endorsements
The reader will conclude “Gun Graffiti” being easy to remove and replace with new “Gun Graffiti” with a different advertiser.
The reader will conclude how “Gun Graffiti” can make person stand out from a crowd.

Although the description above has some specificities, these should not create bias as limiting the scope the new innovation but as a way of providing illustrations of some of the preferred embodiments.

We claim:

1. An undetermined width and length of material with elastic like properties with any visual graphics to fit snug around the nozzle of a barrel.
(i) Width and length of material with elastic said properties with a manufactured seem to fit barrel, this dependent claim relates to independent claim 1
(ii) Width and length of material with elastic said properties with material adhering mechanism not manufactured in, this dependent claim relates to independent claim 1.
(iii) Width and length of material with hard said properties with a manufactured seem to fit barrel, this dependent claim relates to independent claim 1
(iv) Width and length of material with hard said properties with material adhering mechanism not manufactured in, this dependent claim relates to independent claim 1.
(v) Width and length of material with soft said properties with a manufactured seem to fit barrel, this dependent claim relates to independent claim 1
(vi) Width and length of material with soft said properties with material adhering mechanism not manufactured in, this dependent claim relates to independent claim 1.
